(19) United States
(12) Patent Application Publication
(10) Pub. No.: US 2025/0196777 A1
(43) Pub. Date: Jun. 19, 2025

(54) ATTACHMENT/DETACHMENT STRUCTURE FOR VEHICLE CARGO

(71) Applicant: CAR MATE MFG. CO., LTD., Tokyo (JP)

(72) Inventors: Tatsuyuki AONO, Tokyo (JP); Takuya OMORI, Tokyo (JP); Hisashi NAKAMURA, Tokyo (JP)

(73) Assignee: CAR MATE MFG. CO., LTD., Tokyo (JP)

(21) Appl. No.: 18/849,008

(22) PCT Filed: Jan. 25, 2023
(86) PCT No.: PCT/JP2023/002293

§ 371 Date: Sep. 20, 2024

(30) Foreign Application Priority Data
Mar. 22, 2022 (JP) 2022-045314

(51) Int. Cl. B60R 9/048

(52) U.S. Cl. CPC B60R 9/048

(57) ABSTRACT

An attachment/detachment structure for a vehicle cargo includes a first engaging portion and a second engaging portion placed in a cargo, fixed holding means that is fixed to a vehicle side to hold any one of the first engaging portion and the second engaging portion, and movable holding means that is fixed to a vehicle side to hold another one of the first engaging portion and the second engaging portion. The movable holding means includes a movable portion that allows operation of shifting between a fixed position at which the other engaging portion is held and a released position spaced from the other engaging portion, and a lock mechanism that controls operation of the movable portion shifting to the released position at the fixed position.

### TECHNICAL FIELD

The present invention relates to a structure for attaching/detaching a cargo, and in particular, to a structure suitable for attaching/detaching a cargo to/from a roof, a rear hatch (back door), and so on of a vehicle.

### BACKGROUND ART

A cargo box is sometimes attached to a roof or a rear hatch of a vehicle for the purpose of increasing the capacity of a loading space of the vehicle or of enabling efficient use of the passenger compartment of the vehicle. Such a storage box has conventionally been used while being fixed to the vehicle because the purpose thereof is simply to increase the loading capacity. Thus, the storage box is configured to be fixed in such a way that it cannot be easily attached/detached to/from the outside.

However, in recent years, there has been an increase in cases of carrying a lot of luggage at a destination for outdoor activities such as camping. Accordingly, technologies disclosed in Patent Documents 1 and 2 have been gaining attention. The technologies allow a storage box attached to a vehicle to be easily attached/detached and allow the whole storage box to be carried.

According to the technology disclosed in Patent Document 1, a mounting base to which a storage box is secured is fixed to a support base for a spare tire provided on a rear hatch, and the storage box can be attached/detached to/from the mounting base. The storage box is attached/detached to/from the mounting base by recess-protrusion fitting between a lower end edge of a flange provided on the peripheral edge of the mounting base and engaging portions provided on both side edges thereof.

It is indeed considered that such a structure makes it easy to attach/detach the storage box and also enables the whole storage box to be carried. However, in Patent Document 1, the structure of the engaging portions is unclear, and therefore, concerns remain as to whether the storage box can be smoothly attached/detached and whether the storage box can be securely fixed.

The technology disclosed in Patent Document 2 is intended to make a storage box, which is placed on a carrier bar fixed to a roof, attachable/detachable. Specifically, a pair of fixing brackets is placed across two front and rear carrier bars placed in the width direction of the vehicle. One of the fixing brackets making the pair is formed with a locking pawl, and the other is formed with a receiving hole. On the rear surface of the storage box (surface facing the fixing brackets), a receiving metal fitting having a locking hole with which the locking pawl engages, and a hook metal fitting insertable into the receiving hole are disposed. Then, the storage box is completely fixed by inserting the locking pawl into the locking hole, inserting the hook metal fitting into the receiving hole, and tightening a clamping bolt provided in the receiving hole.

According to such a structure, the storage box can be attached/detached merely by operating the clamping bolt from the outside. However, the technology disclosed in Patent Document 2 involves inserting the pawl for locking and the pawl for fixing into the receiving hole from different directions, which requires a cargo such as the storage box to be three-dimensionally moved. Accordingly, in a case where the weight of the cargo is increased, it may be difficult to perform operation for attaching/detaching the cargo. Further, the clamping bolt manually tightened can loosen due to vibrations or shaking while the vehicle travels. Also, there is a concern that it is difficult to determine whether the tightened state is adequate.

### CITATION LIST

### Patent Literature

Patent Document 1: JP-A-10-211851
Patent Document 2: Japanese Registered Utility Model No. 3020403

### DISCLOSURE OF THE INVENTION

### Problems to be Solved by the Invention

The present invention has been achieved in light of such problems, and therefore, an object of the present invention is to provide an attachment/detachment structure for a vehicle cargo which enables a vehicle cargo to be easily attached/detached and to be securely fixed.

### Solutions to the Problems

In order to achieve the object described above, an attachment/detachment structure for a vehicle cargo according to the present invention including: a first engaging portion placed along one side that is a side of a first main surface of a cargo and a second engaging portion placed along another side that is provided at a position opposite to the one side; and holding means that holds the first engaging portion and the second engaging portion by a combination of fixed holding means and first movable holding means, or, alternatively, a combination of second movable holding means and the first movable holding means, in which the fixed holding means and the second movable holding means are fixed to a vehicle side to hold any one of the first engaging portion and the second engaging portion, and the first movable holding means and the second movable holding means are fixed to a vehicle side to hold another one of the first engaging portion and the second engaging portion, and the first movable holding means and the second movable holding means have a movable portion that allows operation of shifting between a fixed position at which the one of the first engaging portion and the second engaging portion or the other one of the first engaging portion and the second engaging portion is held and a released position spaced from the one of the first engaging portion and the second engaging portion or the other one of the first engaging portion and the second engaging portion, and a lock mechanism that controls operation of the movable portion shifting to the released position at the fixed position.

In the attachment/detachment structure for a vehicle cargo having the features described above, the fixed holding means and the second movable holding means that is in the fixed position can have a first recessed portion that is formed in a direction along a surface on which the first main surface is placed when the cargo is loaded, the first movable holding means can have a second recessed portion that is formed in a direction along a surface on which the first recessed portion is formed in the fixed position, and the first engaging portion and the second engaging portion can be pins or protrusions that can be fitted into the first recessed portion and the second recessed portion. According to such a feature, the engaging portions and the holding means can be connected by recess-protrusion fitting from a certain direction, so that the cargo can be fixed easily and securely.

In the attachment/detachment structure for a vehicle cargo having the features described above, the fixed holding means and the second movable holding means that is in the fixed position may have a first protrusion that is formed in a direction along a surface on which the first main surface is placed when the cargo is loaded, the first movable holding means may have a second protrusion that is formed in a direction along a surface on which the first protrusion is formed in the fixed position, and the first engaging portion and the second engaging portion may be recessed portions into which the first protrusion and the second protrusion can be fitted. According to such a feature also, the engaging portions and the holding means can be connected by recess-protrusion fitting from a certain direction, so that the cargo can be fixed easily and securely.

In the attachment/detachment structure for a vehicle cargo having the features described above, the first engaging portion and the second engaging portion preferably have a recess in the cargo, and in a case where the fixed holding means or the second movable holding means holds the one of the first engaging portion and the second engaging portion, and in a case where the first movable holding means hold the other one of the first engaging portion and the second engaging portion, the fixed holding means or the second movable holding means, and at least a part of the first movable holding means can be preferably fitted into the recesses. According to such a feature, in a case where the cargo is fixed by the fixed holding means and the movable holding means, a part extending beyond the outer periphery of the cargo is reduced. This reduces a wind noise and the like when the vehicle is running.

In the attachment/detachment structure for a vehicle cargo having the features described above, the fixed holding means or the second movable holding means, and the first movable holding means are preferably provided at positions opposite to each other via the cargo. According to such a feature, even in a case where the cargo is loaded and the holding means positioned behind the cargo cannot be visually checked, the positioning can be performed with the placement position of the movable holding means used as a marker.

In the attachment/detachment structure for a vehicle cargo having the features described above, preferably, the fixed holding means or the second movable holding means, and the first movable holding means are fixed to a base that can bear a weight of the cargo, and in a case where the first movable holding means and the second movable holding means are so configured that, in the released position, upper end surfaces thereof are parallel to a bearing surface of the base. According to such a feature, even in a case where the cargo is loaded onto the base and straddles the movable holding means, it is possible to load the cargo stably and slide the cargo.

In the attachment/detachment structure for a vehicle cargo having the features described above, the base preferably includes a frame having a frame-like shape, and placement positions of the fixed holding means or the second movable holding means, and the first movable holding means are preferably changeable along the frame. According to such a feature, it is possible to fix the cargo regardless of the size of the cargo.

In the attachment/detachment structure for a vehicle cargo having the features described above, the base is preferably attached to a carrier bar fixed to the vehicle via a mounting bracket with which the placement positions are changeable along the frame. According to such a feature, the base can be attached to the carrier bar regardless of the placement position (width) of the carrier bar.

### Effects of the Invention

According to the attachment/detachment structure for a vehicle cargo, the vehicle cargo can be easily attached/detached and can be securely fixed.

### BRIEF DESCRIPTION OF THE DRAWINGS

FIG. 1 is a side cross-sectional view illustrating a relationship between fixed holding means as well as movable holding means and a cargo including a first engaging portion and a second engaging portion, which are basic forms of an attachment/detachment structure.

FIG. 2 is a side view illustrating a form of the fixed holding means.

FIG. 3 is a side cross-sectional view illustrating a form of the movable holding means in a fixed position.

FIG. 4 is a side cross-sectional view illustrating a form of the movable holding means in a released position.

FIG. 5 is diagrams illustrating how a cargo is fixed and released by an attachment/detachment structure according to an embodiment.

FIG. 6 is a perspective view illustrating an arrangement of a base, a carrier bar, the fixed holding means, and the movable holding means.

FIG. 7 is a partial cross-sectional view illustrating a state in which a mounting bracket is fixed to the base.

FIG. 8 is a perspective view illustrating a form of a mounting bracket applied to a carrier bar having a rectangular cross section.

FIG. 9 is a perspective view illustrating a form of a mounting bracket applied to a carrier bar having a T-shaped groove on an upper surface.

FIG. 10 is a perspective view illustrating an example in which the base is fixed to the carrier bar having a T-shaped groove.

FIG. 11 is a diagram illustrating a first modification to the attachment/detachment structure according to the embodiment.

FIG. 12 is a diagram illustrating a cross-section taken along line E-E in FIG. 11.

FIG. 13 is a perspective view illustrating a second modification to the attachment/detachment structure according to the embodiment.

### DESCRIPTION OF PREFERRED EMBODIMENTS

Hereinafter, a detailed description is given of an embodiment related to an attachment/detachment structure for a vehicle cargo according to the present invention with reference to the drawings.

### First Embodiment: Configuration

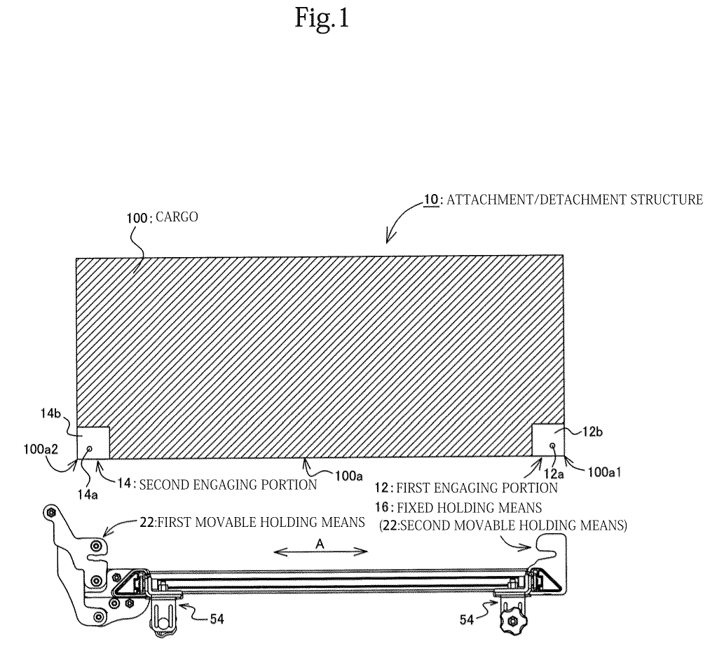

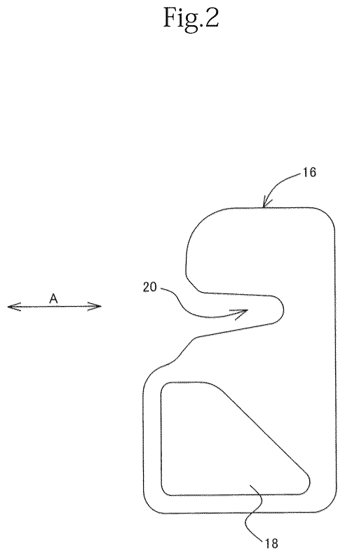

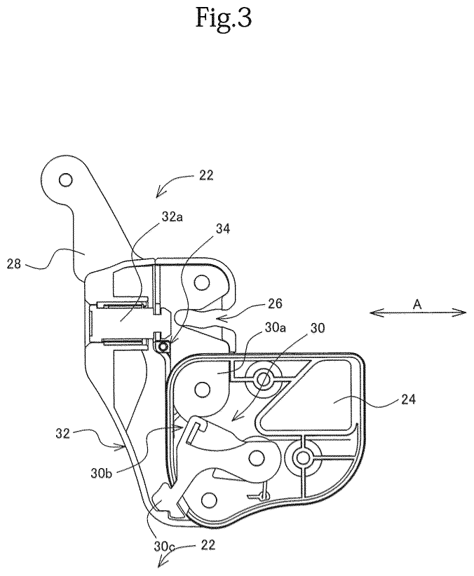

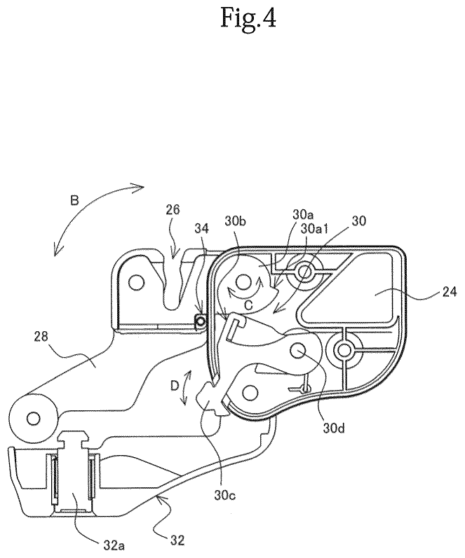

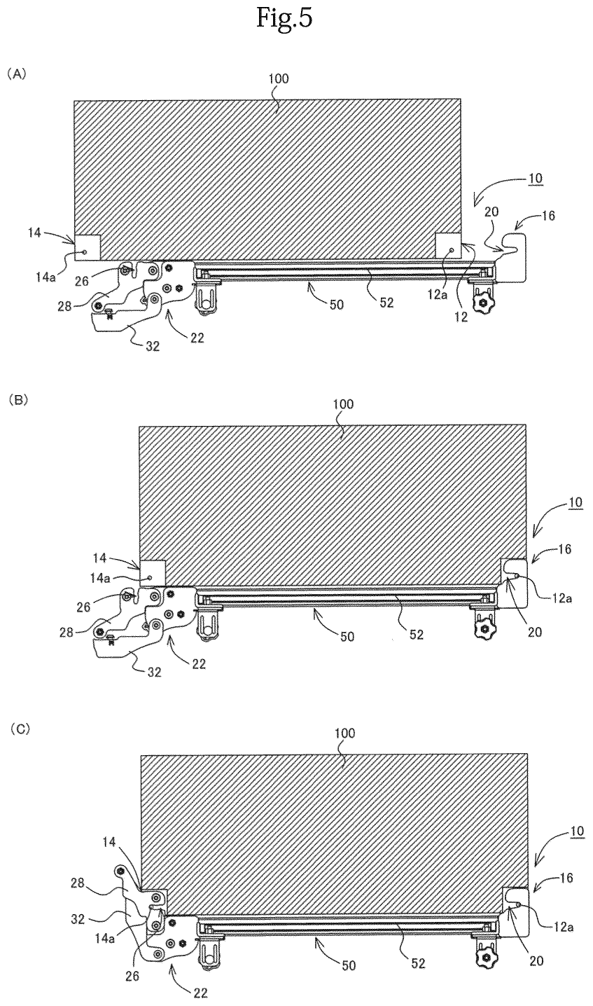

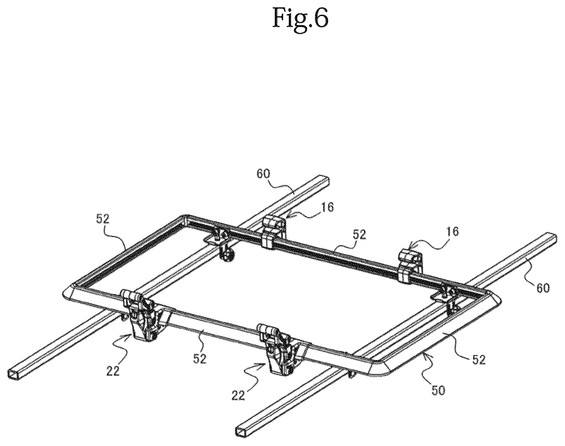

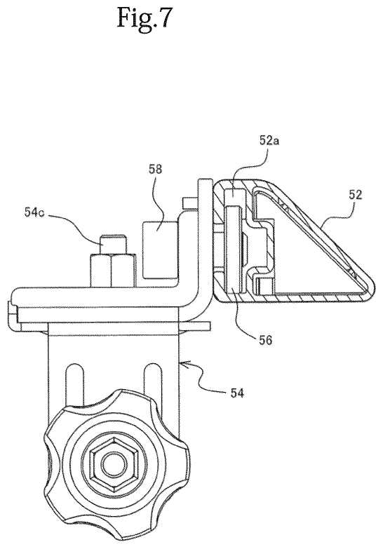

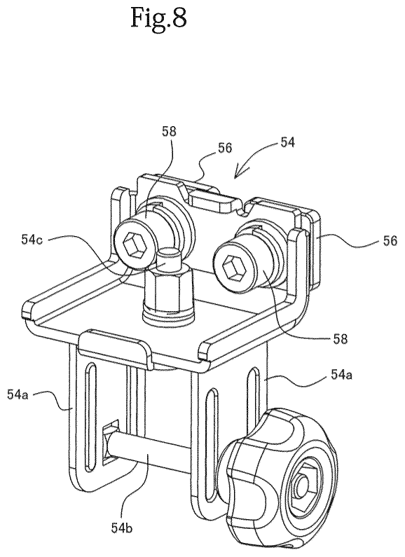

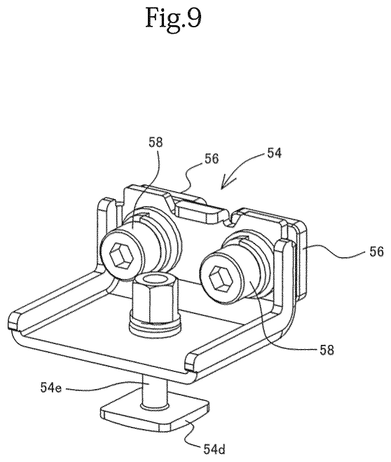

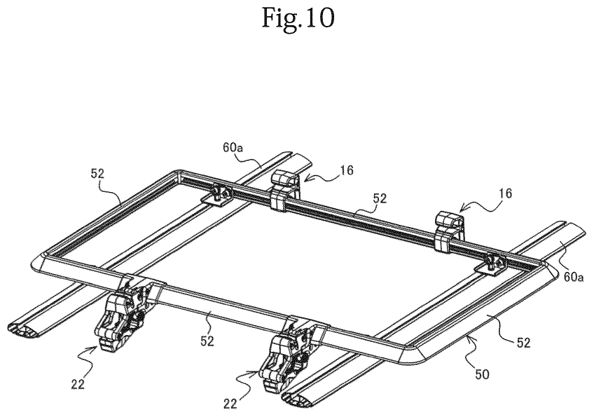

First, a basic embodiment of an attachment/detachment structure for a vehicle cargo (hereinafter simply referred to as an attachment/detachment structure 10) will be described with reference to FIGS. 1 to 10. In the drawings, FIG. 1 is a side cross-sectional view illustrating a relationship between fixed holding means as well as movable holding means and a cargo including a first engaging portion and a second engaging portion, which are basic forms of the attachment/detachment structure. FIG. 2 is a side view illustrating a form of the fixed holding means, and FIG. 3 is a side cross-sectional view illustrating a form of the movable holding means in a fixed position. FIG. 4 is a side cross-sectional view illustrating a form of the movable holding means in a released position. FIG. 5 is diagrams illustrating how a cargo is fixed and released by the attachment/detachment structure according to the embodiment. FIG. 6 is a perspective view illustrating an arrangement of a base, a carrier bar, the fixed holding means, and the movable holding means. FIG. 7 is a partial cross-sectional view illustrating a state in which a mounting bracket is fixed to the base. FIG. 8 is a perspective view illustrating a form of a mounting bracket applied to a carrier bar having a rectangular cross section. FIG. 9 is a perspective view illustrating a form of a mounting bracket applied to a carrier bar having a T-shaped groove on an upper surface. FIG. 10 is a perspective view illustrating an example in which the base is fixed to the carrier bar having a T-shaped groove.

The attachment/detachment structure 10 according to the present embodiment basically includes a first engaging portion 12, a second engaging portion 14, fixed holding means 16, and movable holding means (first fixed holding means) 22. In the attachment/detachment structure 10 according to the present embodiment, the fixed holding means 16 and the movable holding means 22 are positioned via a base 50 fixed to a carrier bar 60 attached to a roof of a vehicle (see FIG. 6). The base 50 according to the present embodiment includes a frame 52 assembled in a rectangular frame shape, and is fixed to the carrier bar attached to the vehicle via a mounting bracket 54 detailed later. Further, the first engaging portion 12 and the second engaging portion 14 are disposed in the exterior of the cargo.

The first engaging portion 12 and the second engaging portion 14 are elements held by the fixed holding means 16 and the movable holding means 22, respectively, which are detailed later. In the present embodiment, the first engaging portion 12 and the second engaging portion 14 have the same structure. Specifically, the first engaging portion 12 and the second engaging portion 14 according to the embodiment include recesses 12b and 14b and pins 12a and 14a, respectively. The recesses 12b and 14b are provided along one side 100al of a first main surface 100a (surface to be positioned to face the vehicle onto which a cargo 100 is loaded) of the cargo 100 and another side 100a2 facing that one side 100al, respectively. The pins 12a and 14a are provided for the recesses 12b and 14b respectively along the direction in which the sides of the first main surface 100a are aligned.

The fixed holding means 16 is an element with which any one of the first engaging portion 12 and the second engaging portion 14 (hereinafter, in the present embodiment, one of them is assumed to be the first engaging portion 12 and the other is assumed to be the second engaging portion 14) engages. In the present embodiment, the fixed holding means 16 includes a fixed portion 18 and a holding portion 20, and is fixed to the frame 52 of the base 50 via the fixed portion 18 so as to be erected vertically. The cargo 100 is so loaded that the first main surface 100a runs along the frame 52 of the base 50. Accordingly, the fixed holding means 16 is vertically erected to the frame 52, which stops and positions the cargo 100 that has been slid on the frame 52.

The holding portion 20 is constituted by a recessed portion formed in a direction along a surface on which the first main surface 100a of the cargo 100 is placed (in a direction indicated by the arrow A). The opening of the recessed portion is provided to face a direction in which the movable holding means 22 detailed later is placed. Such a configuration allows the cargo 100 to be clamped between the fixed holding means 16 and the movable holding means 22. The pin 12a of the first engaging portion 12 is inserted into the recessed portion constituting the holding portion 20. Accordingly, the holding portion 20 is provided at a height where the pin 12a is located when the cargo 100 is loaded onto the frame 52. Such a configuration allows the pin 12a of the first engaging portion 12 to be inserted into the holding portion 20 (recessed portion) merely by sliding the cargo 100 loaded onto the frame 52 toward the fixed holding means 16.

The movable holding means 22 is an element with which the other of the first engaging portion 12 and the second engaging portion 14 (in the present embodiment, the second engaging portion 14) engages. In the present embodiment, the movable holding means 22 includes a fixed portion 24, a holding portion 26, a movable portion 28, and a lock mechanism 30, and is fixed to the frame 52 of the base 50 via the fixed portion 24. The movable portion 28 is a pivot element that shifts the holding portion 26 of the movable holding means 22 between a fixed position and a released position. Here, the fixed position means a position at which the movable portion 28 is erected vertically to the frame 52. On the other hand, the released position means a state in which the movable portion 28 is not in a position vertical to the frame 52. In the present embodiment, the released position particularly means a position at which the movable portion 28 is parallel to the frame 52. The released position of the movable portion 28 is set to a position parallel to the frame 52. Thereby, even if the cargo 100 is loaded onto the frame 52 of the base 50 so as to straddle the movable holding means 22, there is no possibility that the cargo 100 rides up on the movable holding means 22 and tilts. Therefore, the cargo 100 can be slid toward the fixed holding means 16 while the cargo 100 remains in a stable condition.

The lock mechanism 30 is an element that, when the movable portion 28 is in the fixed position, serves to maintain the fixed position, in other words, serves to control the movement of the movable portion 28 shifting to the released position. The lock mechanism 30 can have any configuration as long as the lock mechanism 30 fulfills the function. In one example, as illustrated in FIGS. 3 and 4, it is only required that the lock mechanism 30 includes a cam 30a, a stopper 30b, and a release lever 30c. The cam 30a is an element that rotates (moves in the direction indicated by the arrow C) together with the pivotal movement (movement in the direction indicated by the arrow B) of the movable portion 28. The cam 30a has a step portion 30a1 on a part of the outer periphery thereof. The stopper 30b is an element that, when the movable portion 28 reaches the fixed position, fits in the step portion 30al of the cam 30a to prevent the rotation of the cam 30a, i.e., the pivot of the movable portion 28. The release lever 30c is an element that raises the stopper 30b fitted in the step portion 30a1 to allow the cam 30a to pivot. In the present embodiment, the release lever 30c is configured to be pivotable (moved in the direction indicated by the arrow D) around a pivot 30d, and the lever is biased toward the cam 30a. Then, the stopper 30b is configured to be attached to the release lever 30c. With such a configuration, when the movable portion 28 reaches the fixed position, the stopper 30b automatically fits in the step portion 30al due to the biasing force toward the release lever 30c, which controls the pivotal movement of the movable portion 28. In a state where the pivotal movement of the movable portion 28 is controlled, the release lever 30c is operated to raise the stopper 30b from the step portion 30al, which allows the movable portion 28 to pivot.

The holding portion 26 is constituted by a recessed portion formed in a direction along the surface on which the first main surface 100a of the cargo 100 is placed (in a direction indicated by the arrow A) when the movable portion 28 is in the fixed position. The recessed portion is so configured that the opening faces a direction in which the fixed holding means 16 described above is placed. Such a configuration allows the cargo 100 to be clamped between the fixed holding means 16 and the movable holding means 22. The pin 14a of the second engaging portion 14 is inserted into the recessed portion constituting the holding portion 26. Accordingly, the holding portion 26 is provided at a height where the pin 14a is located when the cargo 100 is loaded onto the frame 52. Such a configuration allows the pin 14a of the second engaging portion 14 to be inserted into the holding portion 26 (recessed portion) merely by shifting the movable portion 28 from the released position to the fixed position in a state where the cargo 100 is loaded onto the frame 52.

Here, in the holding portion 20 of the fixed holding means 16, the recessed portion has a straight structure, while the recessed portion constituting the holding portion 26 of the movable holding means 22 has side surfaces with a vertically undulating structure, which is illustrated in detail in FIGS. 3 and 4. Such a configuration makes it less likely that, when the movable portion 28 pivots, a gap is created between the upper surface of the recessed portion and the pin 14a inserted from the opening side of the holding portion 26. As a result, the fixed cargo 100 can be prevented from rattling.

Further, in the attachment/detachment structure 10 according to the present embodiment, a cover 32 for preventing the release lever 30c from being operated is provided on the movable holding means 22. The cover 32 is provided with a key 32a for controlling the opening/closing operation of the cover 32. With such a configuration, in the attachment/detachment structure 10, it is possible to prevent the movable holding means 22 from shifting to the released position in response to the release lever 30c operated due to mischief, malfunction, and so on.

Further, in the attachment/detachment structure 10 according to the present embodiment, the movable portion 28 is provided with an abutting portion 34. In a case where the movable portion 28 is in the released position, the abutting portion 34 abuts on the exterior of the fixed portion 24 to transmit the load. Such a configuration allows the vertical load applied to the movable portion 28 in the released position to be transmitted to the exterior of the fixed portion via the abutting portion 34. Therefore, even in a case where a large load in response to the cargo 100 loaded is applied onto the movable portion 28 that is in the released position, damage to the movable portion 28 can be prevented.

The frame 52 of the base 50 according to the present embodiment has a substantially triangular cross section as illustrated in FIG. 7. The frame 52 is formed with a guide groove 52a in a side positioned on the inner periphery of the base 50 to which the frame 52 is assembled to have a frame shape. The mounting bracket 54 is placed in the guide groove 52a via a nut 56 and a bolt 58, which enables the mounting bracket 54 to be moved and positioned along the layout of the frame 52.

In the meantime, the mounting bracket 54 can be a type of clamp for a rod-like carrier bar 60 as illustrated in FIG. 8, or, alternatively, can be configured to conform to a carrier bar 60a with a T-shaped groove (see FIG. 10) as illustrated in FIG. 9. The mounting bracket 54 illustrated in FIG. 8 is fixed to the carrier bar 60 by using a tap bolt 54c to hold down the carrier bar 60 passing through the upper part of a bar 54b placed across the pair of side frames 54a provided in the lower half. The fastener 54 illustrated in FIG. 9 is fixed to the carrier bar 60a by fitting a nut 54d in the T-shaped groove of the carrier bar 60a, pulling up the nut 54d with a tightening bolt 54e, and pressing it against the T-shaped groove.

### [Action]

Next, with reference to FIG. 5, how to fix/release the cargo 100 by the attachment/detachment structure 10 configured as described above will be described. In the attachment/detachment structure 10 configured as described above, first, as illustrated in FIG. 5(A), the movable portion 28 of the movable holding means 22 is set to the released position and the cargo 100 is placed on the frame 52 of the base 50. Then, as illustrated in FIG. 5(B), the cargo 100 placed on the frame 52 is slid toward the fixed holding means 16, and the pin 12a of the first engaging portion 12 is fitted into the holding portion 20 of the fixed holding means 16. After the pin 12a of the first engaging portion 12 is fitted into the holding portion 20, as illustrated in FIG. 5(C), the movable portion 28 of the movable holding means 22 is pivoted to the fixed position, and the pin 14a of the second engaging portion 14 is fitted into the holding portion 26. The movable holding means 22 is shifted to the fixed position, so that the lock mechanism 30 acts in a state where the pin 14a of the second engaging portion 14 is fitted into the holding portion 26, and the cargo 100 is completely fixed. When the cargo 100 is completely fixed, the release lever 30c is sealed by the cover 32 provided on the movable holding means 22 and the key 32a is used to lock the cover 32. This prevents the lock mechanism 30 from being released due to mischief or malfunction.

In order to unload the cargo 100 (in order to release the fixed state of the cargo 100), the key 32a is used to unlock the cover 32, the cover 32 is released, and then the release lever 30c of the lock mechanism 30 is operated to raise the stopper 30b from the step portion 30a1 of the cam 30a, so that the locked state by the lock mechanism 30 is released. Releasing the locked state allows the movable portion 28 of the movable holding means 22 to pivot from the fixed position to the released position. After the movable portion 28 is shifted to the released position, the cargo 100 is moved in a direction away from the fixed holding means 16, so that the pin 12a of the first engaging portion 12 is pulled out from the holding portion 20, and the fixation of the cargo 100 is released. After the pin 14a is pulled out from the holding portion 20, the cargo 100 is put down from the base 50, and the cargo 100 is completely unloaded.

### [Effect]

According to the attachment/detachment structure 10 having the features described above, after the cargo 100 is loaded onto the base 50, the cargo 100 can be positioned, fixed, and removed merely by sliding the cargo 100 on a flat surface. Thus, the cargo 100 can be easily attached/detached and can be securely fixed. Further, the fixed holding means 16 and the movable holding means 22 are placed at positions opposite to each other. Thereby, even in a case where the cargo 100 is loaded onto the base 50 and the fixed holding means 16 is positioned at a blind spot due to the cargo 100 and cannot be visually checked, the pin 12a of the first engaging portion 12 can be fitted into the holding portion 20 of the fixed holding means 16 by positioning the second engaging portion 14 at the position of the movable holding means 22.

Further, in a case where the movable portion 28 of the movable holding means 22 is shifted to the released position, the upper end thereof is set to be parallel to the frame 52 of the base 50. This allows the cargo 100 to be loaded stably and to be slid, and also allows the movable holding means 22 to assist in loading the cargo 100.

Further, in a case where the first engaging portion 12 and the second engaging portion 14 are provided in the cargo 100, the recess 14b into which a part of the fixed holding means 16 or the movable holding means 22 can be fitted. This can reduce a part exposed to the outside in a state where the cargo 100 is fixed. It is therefore possible to prevent a wind noise and the like when the vehicle is running.

Further, the positions at which the fixed holding means 16, the movable holding means 22, and the mounting bracket 54 are fixed are flexibly changeable along the frame 52. This makes it possible to load and fix the cargo 100 within a size range of the frame 52 regardless of the size of the cargo 100 and the width with which the carrier bar 60 is positioned.

### [First Modification]

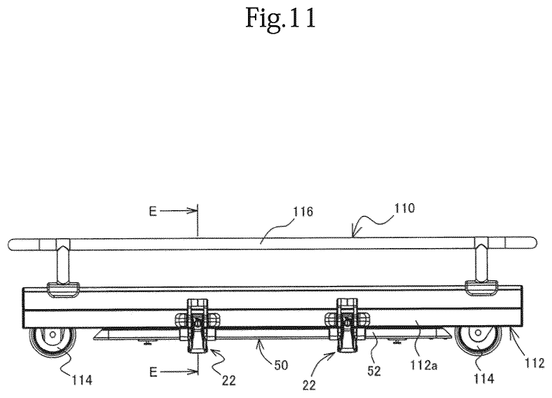

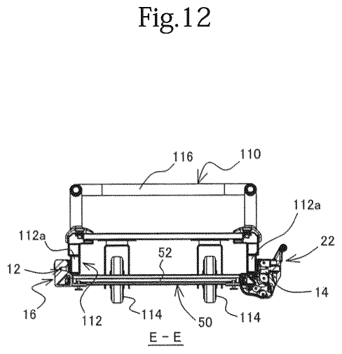

Next, the first modification to the attachment/detachment structure 10 according to the embodiment will be described with reference to FIGS. 11 and 12. Note that the basic structure in this modification is similar to that of the attachment/detachment structure 10 according to the basic form described above. Thus, parts having the same functions will be identified with the same reference symbols in the drawings and detailed descriptions thereof will be omitted.

In the embodiment described above, the cargo 100 has a box shape, and the first engaging portion 12 and the second engaging portion 14 are configured by placing the recess 14b and the pin 14a in the exterior of the cargo 100. However, the cargo 100 is not limited to have a box shape. For example, the cargo 100 may be a push cart 110 as illustrated in FIGS. 11 and 12. Although the push cart 110 can have any form, the example illustrated in FIGS. 11 and 12 includes a push cart body 112 equipped with wheels 114 and a guide pipe 116 provided at the upper part of the push cart body 112.

In this modification, the first engaging portion 12 and the second engaging portion 14 are provided on a pair of main frames 112a provided along the longitudinal direction of the push cart body 112. As described above, even if the first engaging portion 12 and the second engaging portion 14 are provided so as to protrude from the push cart 110 as a cargo, the push cart 110 that is a cargo can be stably fixed and easily attached/detached without fail.

### [Second Modification]

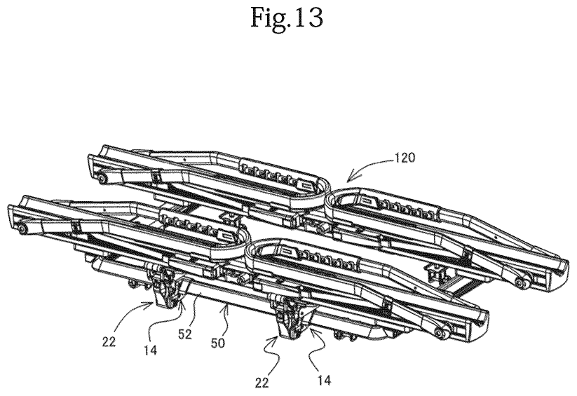

Further, a cargo to which the attachment/detachment structure 10 according to the embodiment is applied does not necessarily have to be intended to be attached and detached when the cargo is used. For example, as illustrated in FIG. 13, the cargo may be a bicycle carrier 120, and the first engaging portion 12 (not illustrated in FIG. 13) and the second engaging portion 14 may be placed on a base frame of the bicycle carrier 120. As described above, a carrier specialized for a particular application is configured to be attachable/detachable, so that the dedicated carrier can be easily and quickly attached/detached depending on the purpose of use.

### INDUSTRIAL APPLICABILITY

In each of the embodiment and the modifications, the first engaging portion 12 and the second engaging portion 14 are fixed (permanently installed) to the cargo 100. However, as long as the first engaging portion 12 and the second engaging portion 14 can be securely fixed, the first engaging portion 12 and the second engaging portion 14 may be attached to the cargo 100 later. This is because even in the case of such a configuration, the cargo 100 can be easily attached/detached, and the cargo 100 can be securely fixed. Further, in the case of such a configuration, the first engaging portion 12 and the second engaging portion 14 can be shared by a plurality of cargos 100.

Further, in the embodiment described above, the pins 12a and 14a (protrusions) are used as the first engaging portion 12 and the second engaging portion 14, respectively, and the holding portion 20 of the fixed holding means 16 and the holding portion 26 of the movable holding means 22 are formed to have a recess, and then, the pins 12a and 14a are fitted into the holding portions 20 and 26, respectively. However, the relationships between protrusions and recesses are not limited. Although not illustrated, the first engaging portion 12 and the second engaging portion 14 may be formed to have a recess (formed in a recessed portion) and the holding portion 20 of the fixed holding means 16 and the holding portion 26 of the movable holding means 22 may be formed to have a protrusion (formed in a first protrusion and a second protrusion). This is because even in the case of such a configuration, the procedure and effort for attaching/detaching the cargo 100 remain the same.

According to each of the embodiment and the modifications, in the attachment/detachment structure 10, the fixed holding means 16 and the movable holding means 22 hold the first engaging portion 12 and the second engaging portion 14, respectively. However, even if the movable holding means 22 (first movable holding means and second movable holding means) is used as each of the holding means for the first engaging portion 12 and the second engaging portion 14, the attachment/detachment structure 10 according to the present invention can be achieved. Specifically, it is preferable that the second movable holding means is placed instead of the fixed holding means 16, and the cargo 100 is clamped between the first movable holding means and the second movable holding means. Here, the first movable holding means and the second movable holding means have a common configuration and can have a configuration similar to that of the movable holding means 22 described above. In such a configuration, in a case where the width (length) of the cargo 100 is equal to the width of the vehicle, the cargo 10 can be loaded and unloaded from both side surfaces of the vehicle.

Further, in each of the embodiment and the modifications, the fixed holding means 16 and the movable holding means 22 are fixed to the base 50 that is fixed to the carrier bar 60 attached to the roof of the vehicle. However, it is only required that the fixed holding means 16 and the movable holding means 22 are fixed to a part of the vehicle or an element attached thereto, and to which part the fixed holding means 16 and the movable holding means 22 are fixed is not limited. Specifically, the fixed holding means 16 and the movable holding means 22 may be fixed to the rear hatch part, the interior of the vehicle, or the like.

### DESCRIPTION OF REFERENCE SIGNS

10 ATTACHMENT/DETACHMENT STRUCTURE
12 FIRST ENGAGING PORTION
12a PIN
12b RECESS
14 SECOND ENGAGING PORTION
14a PIN
14b RECESS
16 FIXED HOLDING MEANS
18 FIXED PORTION
20 HOLDING PORTION
22 MOVABLE HOLDING MEANS
24 FIXED PORTION
26 HOLDING PORTION
28 MOVABLE PORTION
30 LOCK MECHANISM
30a CAM
30a1 STEP PORTION
30b STOPPER
30c RELEASE LEVER
30d PIVOT
32 COVER
32a KEY
34 ABUTTING PORTION
50 BASE
52 FRAME
52a GUIDE GROOVE
54 MOUNTING BRACKET
54a SIDE FRAME
54b BAR
54c TAP BOLT
54d NUT
54e TIGHTENING BOLT
56 NUT
58 BOLT
60, 60a CARRIER BAR
100 CARGO
100a FIRST MAIN SURFACE
100al ONE SIDE
100a2 OTHER SIDE
110 PUSH CART
112 PUSH CART BODY
112a MAIN FRAME
114 WHEEL
116 GUIDE PIPE
120 BICYCLE CARRIER

1. An attachment/detachment structure for a vehicle cargo, comprising:
a first engaging portion placed along one side that is a side of a first main surface of a cargo and a second engaging portion placed along another side that is provided at a position opposite to the one side; and
holding means that holds the first engaging portion and the second engaging portion by a combination of fixed holding means and first movable holding means, or, alternatively, a combination of second movable holding means and the first movable holding means, wherein
the fixed holding means and the second movable holding means are fixed to a vehicle side to hold any one of the first engaging portion and the second engaging portion, and the first movable holding means is fixed to a vehicle side to hold another one of the first engaging portion and the second engaging portion, and
the first movable holding means and the second movable holding means have a movable portion that allows operation of shifting between a fixed position at which the one of the first engaging portion and the second engaging portion or the other one of the first engaging portion and the second engaging portion is held and a released position spaced from the one of the first engaging portion and the second engaging portion or the other one of the first engaging portion and the second engaging portion, a lock mechanism that controls operation of the movable portion shifting to the released position at the fixed position, and a cover that is configured to perform opening/closing operation and cover a part of the lock mechanism in a closed state, and
the lock mechanism includes a release lever that releases a function of the lock mechanism, and the cover is configured to, in the closed state, control operation of the release lever in a locked state.

2. The attachment/detachment structure for a vehicle cargo according to claim 1, wherein
the fixed holding means and the second movable holding means that is in the fixed position have a first recessed portion that is formed in a direction along a surface on which the first main surface is placed when the cargo is loaded,
the first movable holding means has a second recessed portion that is formed in a direction along a surface on which the first recessed portion is formed in the fixed position, and
the first engaging portion and the second engaging portion are pins or protrusions that can be fitted into the first recessed portion and the second recessed portion.

3. The attachment/detachment structure for a vehicle cargo according to claim 1, wherein
the fixed holding means and the second movable holding means that is in the fixed position have a first protrusion that is formed in a direction along a surface on which the first main surface is placed when the cargo is loaded,
the first movable holding means has a second protrusion that is formed in a direction along a surface on which the first protrusion is formed in the fixed position, and
the first engaging portion and the second engaging portion are recessed portions into which the first protrusion and the second protrusion can be fitted.

4. The attachment/detachment structure for a vehicle cargo according to claim 1, wherein
the first engaging portion and the second engaging portion have a recess in the cargo, and
in a case where the fixed holding means or the second movable holding means holds the one of the first engaging portion and the second engaging portion, and in a case where the first movable holding means holds the other one of the first engaging portion and the second engaging portion, the fixed holding means or the second movable holding means,
and at least a part of the first movable holding means is allowed to be fitted into the recesses.

5. The attachment/detachment structure for a vehicle cargo according to claim 1, wherein
the movable portion of each of the first movable holding means and the second movable holding means is configured to perform the shifting operation via a fixed portion, and
the movable portion is provided with an abutting portion that abuts on an exterior of the fixed portion when the movable portion is shifted to the released position, and
transmits, to the fixed portion, a vertical load applied to the movable portion in the released position.

6. The attachment/detachment structure for a vehicle cargo according to claim 1, wherein
the fixed holding means or the second movable holding means, and the first movable holding means are fixed to a base that can bear a weight of the cargo, and
in a case where the first movable holding means and the second movable holding means are so configured that, in the released position, upper end surfaces thereof are parallel to a bearing surface of the base.

7. The attachment/detachment structure for a vehicle cargo according to claim 6, wherein
the base includes a frame having a frame-like shape, and
placement positions of the fixed holding means or the second movable holding means, and the first movable holding means are changeable along the frame.

8. The attachment/detachment structure for a vehicle cargo according to claim 7, wherein
the base is attached to a carrier bar fixed to the vehicle via a mounting bracket with which the placement positions are changeable along the frame.
